(19) United States
(12) Patent Application Publication
(10) Pub. No.: US 2009/0083697 A1
(43) Pub. Date: Mar. 26, 2009

(54) Integration of User Interface Design and Model Driven Development

(75) Inventors: Rui Zhang, Beijing (CN); John R. Hajdukiewicz, Minneapolis, MN (US); Conard B. Beaulieu, Deluth, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/859,593

(22) Filed: Sep. 21, 2007

(51) Int. Cl. G06F 9/44; G06F 3/048

(52) U.S. Cl. 717/105; 715/763

(57) ABSTRACT

A system for creating a user interface is disclosed herein. The system comprises (a) a display for viewing a visual representation of the user interface being created, (b) a processor, (c) data storage, and (d) program code stored in the data storage and executable by the processor to (i) implement a UML model explorer that communicates with a model driven design tool to access one or more UML models, (ii) implement a rule-based object visual creation system that is operable to map UML elements to corresponding user interface objects, (iii) in response to input from a user, add corresponding user interface objects to the visual representation, and (iv) implement a model generator that is operable to generate a UML model based on the visual representation of the user interface, wherein the UML model can be executed to create an instance of the user interface on a display.

### FIELD OF THE INVENTION

The present invention relates to user interface design, and more specifically, to taking a model driven design approach to user interface design.

### BACKGROUND OF THE INVENTION

In general, Model Driven Development (MDD) involves creating an abstract model in a defined notation, such that source code and tests can be generated from the model. The model is generally in an abstract visual format, while the source code, defined in the context of the model is generated in a programming language such as Java or C++. This approach allows designers to focus on the architectural and design aspects of a model, and then add code if needed, as they do not have to manually code the model. The Object Management Group (OMG) is a consortium that has developed a standard for the model-driven approach, which is referred to as Model Driven Architecture™ (MDA™). While not necessarily identical, the terms MDD and MDA often are used interchangeably.

While many modeling notations may be used in MDD, the Unified Modeling Language (UML) has emerged as the preferred modeling notation for MDD. UML models generally allow for requirements traceability, multiple views of a solution for each stakeholder, and dependency relationships between modeling elements. In addition, executable software modules (such as Java or C++ programs) can be generated directly from such UML models.

Currently, user interface (UI) modeling tools and UML modeling tools operate separately. In general, UI design systems are visual tools that allow a user to design the appearance of a UI. Behavior and functionality of a UI is not easily captured in such UI design systems in the context of a system's overall architecture and design. Accordingly, the behavior of UIs is usually defined by creating a UML model capturing the behavior or directly programming the code in a programming language. Therefore, the process of creating visual aspects of a user interface is generally separate from the process of coding or modeling the behavior of a user interface. Accordingly, it is desirable to provide a user design system that integrates the design and debugging of behavioral UML models for a UI with the design of the visual aspects of a UI.

### SUMMARY

Disclosed herein is a method and system for a model-centered user interface design system. The system implements a model-centered approach for user interface design, allowing user interface designers to take advantage of modeling approaches, such as UML modeling, when creating user interfaces with a user interface design system. For those familiar with the Model-View-Controller software design pattern the UI design system optimizes the creation of system independent views. The UI design system optimally captures the model and controller aspects of the UI in a system context. The UI design system may also contain some controller capabilities. By integrating user interface design and UML modeling, user-interface designers and software designers can more easily work together to design and verify user interfaces.

In one aspect, a system for creating a user interface is disclosed. The system comprises (a) a display for viewing a visual representation of the user interface being created, (b) a processor, (c) data storage, and (d) program code stored in the data storage and executable by the processor to (i) implement a UML model explorer that communicates with a model driven design tool to access one or more UML models, (ii) implement a rule-based visual design system that is operable to intelligently map UML elements to corresponding user interface objects, (iii) in response to input from a user, add one or more of the corresponding user interface objects to the visual representation of the user interface, and (iv) implement a model generator that is operable to generate a UML model based on the visual representation of the user interface, wherein the UML model can be executed to create an operable instance of the user interface on a display. The program code of the user interface objects may be executable to provide other functionality as well. For example, the UI design system may allow a user to debug a UML model and/or verify a visual representation of a user interface.

In a second aspect, the operable user interface objects additionally implement a simulation system. The simulation system may be operable to (i) detect input from a user input device and in response to the input, manipulate the visual representation of the user interface, (ii) receive a state notification from the model driven design tool, wherein the state notification indicates that one or more of the UML behavioral models has changed state, and (iii) in response to receiving the state notification, update the visual representation of the user interface.

In a third aspect, a method for creating a user interface with a model-centered approach is disclosed. The method comprises (a) importing a UML model to a user interface design tool via a model driven design tool, wherein the UML model comprises UML elements, (b) using the UML elements as a basis for creating user interface objects that can be used in a visual representation to create the user interface, and (c) creating a visual representation of the user interface, wherein the visual representation of the user interface comprises one or more of the user interface objects, and wherein the visual representation is executable to instantiate the user interface on a display. The method may further comprise executing the visual representation to instantiate the user interface on a display.

Animation of the visual representation may be accomplished in various ways. For example, the method may involve generating program code based on the visual representation and executing the program code. Alternatively or additionally, the method may involve generating program code from the UML model and executing that program code. In either case, the visual representation may be executed at runtime (e.g. the program code is both generated and executed at runtime). Custom program code, i.e., code not generated from the visual representation, may be managed and preserved in the model to add cross-object functionality.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

Presently preferred embodiments of the invention are described below in conjunction with the appended drawing figures, wherein like reference numerals refer to like elements in the various figures, and wherein:

FIG. 1 is a simplified process diagram depicting parties and responsibilities involved in a UI design process;

FIG. 2 is a simplified block diagram representing a display created by a UI design system;

FIG. 3 is a conceptual block diagram depicting a UI design system connected to a UML modeling tool;

FIG. 4 is a simplified block diagram depicting components of a UI design system and MDD tool that implement a UI link; and

FIG. 5 is a simplified flow chart illustrating creation logic for mapping UML elements to UI widgets.

### DETAILED DESCRIPTION

Disclosed herein is a method and system for user-interface (UI) design using a model-driven design (MDD) approach. According to the preferred embodiment, a UI design system allows a user to create a UI by visually creating a UI with UI widgets, some of which may have been derived from a UML model. Provided with the UI design system, UI designers can access elements from UML models, incorporating these elements into their UI models. In addition, domain-level programmers (i.e. programmers creating models using UML modeling tools) can use program code from UI widgets when implementing domain specific logic for an application triggered by a UI.

### I. User-Interface Design Process

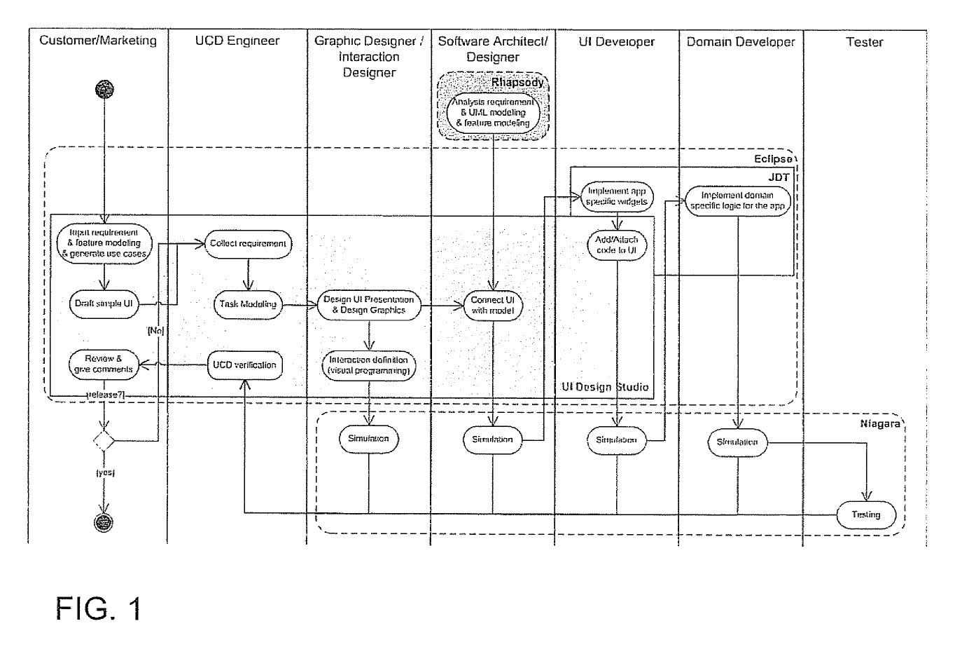

FIG. 1 is a simplified organizational chart 100 depicting roles, tasks, process flow, and tools in a user interface (UI) design process that utilizes an exemplary user interface design system. Generally, the parties are described herein as they are shown, from left to right. The parties may include (A) Customers and Marketing personnel 102, (B) a User-Centered Design (UCD) Engineer 104, (C) a Graphic Designer/Interaction Designer 106, (D) a Software Architect/Designer 108, (E) a UI Developer 110, (F) a Domain Developer 112, and (G) a Tester 114, among others. Note that in various embodiments, combinations or sub-combinations of these roles, tasks, process flow, and tools may be involved in the UI design process. Additional parties may contribute to the process, and further, the responsibilities of the described parties may vary.

Marketing personnel 102 are responsible for gathering information from those who will ultimately use the UI design tool (e.g.; customers, etc.). These personnel may gather required inputs/outputs for the UI and formulate a general idea of the features required by the user interface. In addition, those in the Customer/Marketing role may generate use cases, which illustrate how the user interface will be used in various scenarios. Yet further, Customer/Marketing personnel may draft or sketch a simple UI. The Customer/Marketing personnel may also review and comment on the completed UI design and resubmit it for further development with modified requirements.

A UCD Engineer may then collect information gathered and/or prepared by Marketing/Customer Interaction personnel. They may use this information to create generalized task models. Preferably, they will be able to participate more actively in the design of a UI by using a task modeling system as disclosed in co-owned U.S. application Ser. No. 11/829,597, which is incorporated herein by reference. Alternatively, task modeling may not be implemented, and information from Customer/Marketing personnel may be sent directly to Graphic Designers and/or Interaction Designers.

Graphic Designers and/or Interaction Designers design the visual aspects of the UI. (Note that the roles of Graphic Designer and Interaction Designer may converge at times, and be carried out by the same or different personnel). Preferably, the Graphic/Interface Designer creates the user interface model in a UI design system using a graphical notation to describe the UI. At this stage, the user interface may be aesthetically designed, but may not be functional, as the program code underlying the graphical interface has not been implemented. Thus, UI developers and/or domain developers may be required to implement the functionality envisioned by UI designers.

Preferably, the Graphic/Interface Designer may also design the behavior of a UI using a visual programming language, such as that disclosed in co-owned U.S. application Ser. No. 11/829,596, which is incorporated herein by reference. Provided with such a visual programming language, UI designers may be able to test the functionality of a UI without directly programming or creating a UML model. Even with a visual programming language, lower level modeling and programming (e.g. UML modeling and/or domain specific modeling) may be desirable for more complicated functions of the UI. Thus, a software architect/designer can modify the UI behavior and mappings using an MDD tool, such as Rhapsody (a model-driven development product from Telelogic AB in Sweden), to connect a UI design with a UML model.

### II. Simplified User-Interface Design System

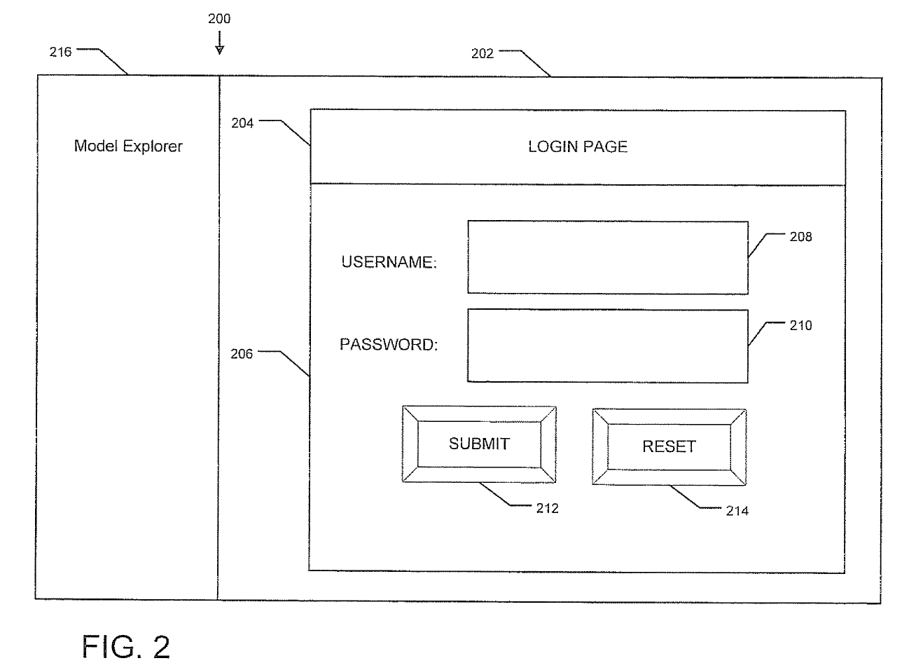

FIG. 2 is a simplified block diagram representing a display 200 from a UI design system, which may be used to create an executable UI. The UI design system display includes a design panel 202 where the UI that is being designed is visually displayed. The design panel 202 displays and/or allows a user to edit one or more UI pages. In this case, design panel 202 is displaying a “Login” UI page, which includes UI widgets 208-214. The display 200 may also include a model explorer 216, a resource explorer 218, and a UI widget palette 220.

A UI including one UI page or multiple UI pages may be designed in the display 200. To do so, UI widget palette 220 may display a visual “list” of various types of UI widgets. Then, to add widgets to a UI page, UI widgets may be dragged and dropped from UI widget palette 220 into design panel 202, or may be added in other ways. Further, resource explorer 218 may be used to navigate between UI pages. The UI page selected in resource explorer 218 may be edited in design panel 202. Each UI page may include UI widgets, such as UI widgets 208-214. Generally, a UI widget (or control) may be an element of an interface that a user interacts with. More specifically, in the UI design system, a UI widget may be a configurable view of a user interface object and further may include at least one implementation of that object. An instance of a UI widget may be an implementation of the user interface object with its visual and preferably configurable representation.

UI widgets may be of various types. For example, the “User name” text box 208 and “Password” text box 210 are both instances of a text box widget and would be bound to a username and password object in a model. The behavior of these two objects may differ. For instance, text entered in the text box for the password object may result in one ‘*’ per entered character. This behavior of showing the actual characters typed or only showing ‘*’s could be controlled by a property for the text box widget.” “Submit” button 212 and “Reset” button 214 are each instances of a button widget (i.e., an instance of the text box widget class), and have a property defining the text displayed by the button. The buttons 212, 214 may also have an event field or property indicating when the button is pushed and/or a method to invoke when the button is pushed. Further, UI widgets may have various properties, which may be pre-defined and/or may be edited by the user. Accordingly, design panel 202 may include a property editor panel 222.

UI widget palette 220 may be used to create UI widgets. The widget palette 220 may provide drag-and-drop functionality to create widgets. For example, a “Button”” or “Text Box” may be dragged from widget palette 220 and dropped in design panel 202 to create Button widgets (such as Login widget 212 and Reset widget 214) and Text Box widgets (such as User Name widget 208 and Password widget 210), respectively.

Display 200 may also include model explorer 216 for providing access to one or more MDD models. Preferably, the model explorer 216 provides access to UML models. The elements of the UML model can then be used to design the functionality of a UI. Preferably, the model explorer 216 displays the elements of a UML model using a directory structure, as shown in FIG. 2, although other formats, such as a tree structure, may be employed. The user can then drag and drop elements from a UML model displayed in model explorer 216 to design panel 202. The UML element may be dropped on a widget 208-214 so that the functionality of the UML element is invoked when the user interacts with the UI widget. Alternatively, a UML element may be associated with a particular type of UI widget. As such, the UML element may be dragged from model explorer 216 and dropped in design panel 202 to create a new UI widget.

Resource explorer 218 may allow a user to quickly navigate among widgets and/or pages of a UI displayed in design panel 202. Further, resource explorer 218 may be presented in similar formats as model explorer 216, such as the depicted directory format or a tree format. The resource panel may be particularly useful for designing UIs having multiple UI pages. For example, in resource explorer 218, the login page is selected (as indicated by the line of surrounding “Login”), and thus design panel 202 is displaying the Login page. The user can navigate between the login page and the reminder page (not shown) using resource explorer 218.

The UI design system may allow a UI designer to enter a simulation state. In the simulation state, certain functions may be disabled or limited. For example, the user may not be able to add, remove, or modify widgets in design panel 202. In the simulation state, a simulated user interface may be displayed. The designer may have been a then interact with the simulated UI to test the functionality of the UI. In particular, when a designer or tester interacts with a widget that is tied to a UML element, the behavior described by the UML element may be carried out (by executing program code, etc.).

Further, when a user creates a UI widget, a UML element corresponding to the widget may be added to the UML model and displayed in model explorer 216. For example, a user might designate a UI page (such as the login page displayed in design panel 202) as a class in a UML model. The user may associate a UI page with a UML class in various ways, such as dragging and dropping a page from resource explorer 218 into a UML model from model explorer 216. Then, when the user adds a UI widget to the UI page, the UI design system may then add a property, which corresponds to the UI widget, to the UI page's UML class.

### III. Integration of UI Design System and MDD Tool

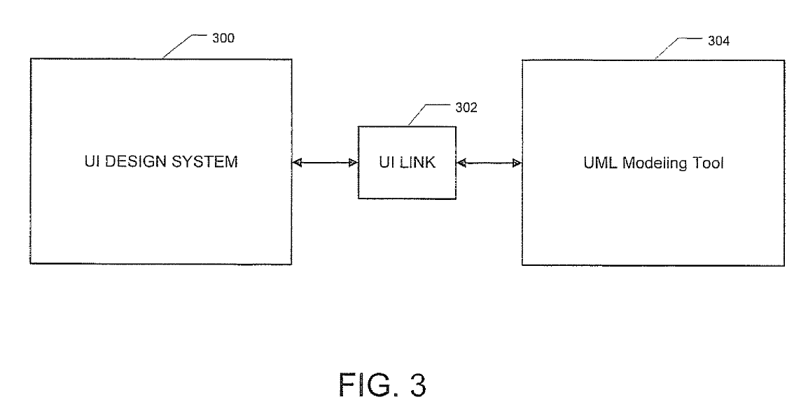

FIG. 3 is a conceptual block diagram depicting a UI design system 300 connected to a UML modeling tool 304 via UI link 302. This arrangement helps integrate an MDD approach with UI design. In particular, UI design system 300 may be operable to access, via UI link 302, UML model elements from UML modeling tool 304. The user may then include the UML elements when designing UIs in the UI design system 300. In addition, UI design system 300 may generate UML elements that correspond to objects making up a UI. In turn, UI link 302 may notify UML modeling tool 304 of a change in the state of the UI, and the UML modeling tool may be updated to reflect the changes (if necessary).

The functionality of UI link 302 may be provided by various components, alone or in combination (e.g. one or more of a UI design system, MDD tool, UML modeling tool, domain-specific modeling tool, etc.). Preferably, much of the link functionality is implemented in the UI design system in conjunction with an MDD tool, such as Telelogic's Rhapsody. Rhapsody includes an interface that is implemented with Microsoft's Component Object Model (COM). Thus, in the preferred embodiment, a UI design system can communicate and control Rhapsody via Rhapsody's COM interface.

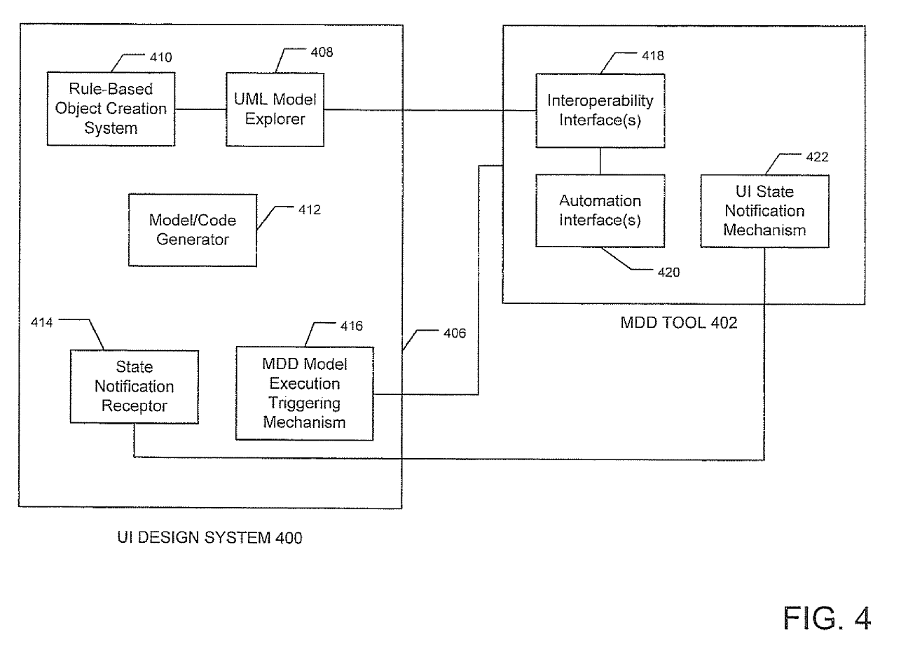

FIG. 4 is a simplified block diagram depicting components of a UI design system 400 and MDD tool 402 that implement a UI link. The UI design system 400 may function in a design state and/or a simulation/debugging state. In the design state, UML model explorer 408, Rule Engine 410, and Model/Code Generator may help integrate UML Models into the design of UI (e.g. the process of describing a UI using a graphical notation). In addition, State Notification System 414 and State Notification Receptor 422 help allow for testing of both a UI, and possibly an underlying UML or domain-specific model, from UI design system 400. Any or all of these functions of UI design system 400 may be facilitated by MDD tool 402. Alternatively, some of these functions may be carried out entirely by MDD tool 402.

A. Creating a User-Interface

UML model explorer 408 may be implemented in various configurations to provide UML model information for the UI Design system. For example, UML model explorer 408 may be communicatively coupled to an interoperability interface 418 of MDD tool 402. Preferably, a UI design system accesses Rhapsody via Rhapsody's COM interface, and in response, Rhapsody provides a UML model tree structure that corresponds to the UML model. Interoperability interface 418 may operate to retrieve information about UML or domain-level models and provide such information to UI design system 400 via UML model explorer 408. Alternatively, UI design system may include a component for understanding models represented in the Intermediate Model Exchange (XMI) file format. In such a configuration, UI design system 400 may export a model from MDD tool 402 to an XMI file. The XMI file can then be used for UI design, integrating elements of the model represented by the XMI file with a UI.

UML model explorer 408 and Rule Engine 410 work together to integrate a UML model with a UI model being designed in UI design system 400. Provided with UML model explorer, a UI design system may be able to recognize or understand characteristics of a UML model (e.g. elements, properties of elements, structure, etc.). A UML model may then be interpreted by Rule Engine 410, so that, for example, UML elements can be represented as widgets used to create a UI with UI design system 400. Further, rules may be defined (automatically or by the user) for UI widgets, and Rule Engine 410 may then maintain the rules.

Once UML model information is retrieved by UML model explorer 408, the UML model may be accessed so that a UML model can be integrated with a UI being designed with the UI design system 400. For example, the UML model may be visually displayed so the user can drag and drop a UML element on a UI widget, binding the UML element to the UI widget. Once bound, Rule Engine 410 may update the properties and/or methods of the UML element according the properties of the UI widget.

Rule Engine 410 may create, maintain, and/or update rules or a set of rules that integrate a UML model or models with a UI. For example, when a user binds a UML element and a UI widget or page (e.g., by dragging and dropping the element, widget, or page), rule engine 410 may define mapping the UI widget to the UML element, thus providing at least some of the functionality associated with the UML element's class structure (e.g., the methods and/or properties of the UML class). Rules may also be used to define properties of a UI widget and the UML element to which the UI widget is linked. Further, rules may tie events associated with a UI widget to methods or properties of UML element to which the UI widget is linked. Additionally, rules may define interactions between UI widgets. Preferably, rules for a UI may be maintained as an XML file, although rules may take various forms without departing from the scope of the invention.

Mapping rules may link or bind a UI widget or page to a UML element. The UML element may be an instance of a UML class, and thus the properties and/or method of the UML class may be provided to the UI widget. For example, a UML model may include a Login class, which includes properties (username, password, etc.) and a methods (e.g., a verify method taking the username and password properties as input, etc.). Dragging and dropping an instance of the Login class (i.e. a UML Login element) on a UI Login page may bind the UI Login Page to the UML Login element. An XML file may define such a rule using the general format such as that described in the Niagara AX Widget Developer's Guide, which is incorporated herein by reference.

Further, the rule set may include rules indicating that further rules should be created when upon the creation of other rules. For instance, when the UI Login page is bound to the UML Login element, text boxes within the UI page may be bound to properties of the UML element. Specifically, UI Text Box widgets may be provide the text for the username and password and thus bound to the user name and password properties of the UML Login element. Further, a UI Button widget, may be bound to the verify method of the UML Login element. In particular, the UI Button widget may include an OnClick method, and this method may be bound to the verify method. Thus, when a user clicks the UI Button widget, the username and password properties of the UML element are set to be whatever text is entered in the UI Text Box widgets. This text is then used as input to the verify function, which verifies the user has a valid username and password.

Rules may also define visual properties of UI widgets, which may or may not be bound to properties of a UML element. For example, a user may be able to right-click a UI widget in the UI Design Panel and access a properties window. In particular, on any given UI widget, the user may be able to adjust the color, shape, borders, etc. Using the example of a “Submit” Button widget, the user might select blue as the color property, and a rounded button shape property. The XML file might represent such rules using the format Page.Widget.property=option. Specifically, the above mentioned properties of a Button widget may be represented by the rules “Login.Submit.color=blue” and “Login.Submit.shape=rounded”.

Further, rules may define relationships between UI widgets, which may or may not require interaction with a UML model. For example, the Button widget may include an OnClick method, and the user may use the UI Design System 400 to define events that are invoked by the OnClick method (i.e. events that occur in response to the event of a user clicking the button). As mentioned, the event may be invoking a method of a UML element, but the event may also be changing a property or invoking another UI widget method. For instance, the user may define the OnClick method to change the color of another UI widget. Such a rule could be captured in the XML file as “if Login.Submit,OnClick then Login.OtherWidget.color=red.”

Alternatively or additionally, Rule Engine 410 may create, maintain, and/or update rules for creating UI widgets based on a UML model. In such embodiments, UI widgets may be added to a UI by simply dragging and dropping a UML element into the UI. In particular. dropping a UML element in the UI Design Panel may result in the creation of a UI widget and the binding of that UI widget to the UML element. In such embodiments, UI design system 400 may include a set of UI widget mapping rules for creating UI widgets from UML elements and/or various other modeling domains (either directly or from an XMI file representing the model(s)). Further, object mapping rules may be defined or expanded by a user of UI design system 400, helping integrate models created in domains using customized notations with a UI designed in UI design system.

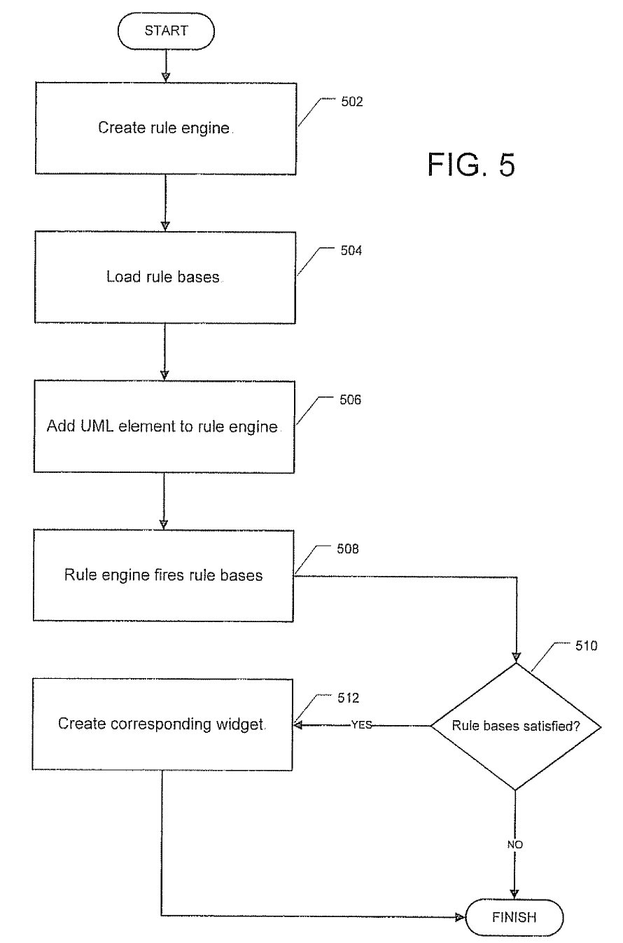

FIG. 5 is a simplified flow chart illustrating creation logic used by the UI design system to map UML elements to UI widgets. First, a rule engine is created, as shown by block 502. Second, rule bases of the rule engine are loaded into the UI being designed, as shown by block 504. Third, the UML element for which the UI widget is to be created is added to the rule engine, as shown by block 506. The rule engine then fires the rule bases, as shown by block 508. Depending on whether or not a rule or rules are satisfied by the UML element, as indicated by the rule bases, a corresponding widget may be created, as shown by decision block 510 and block 512. While the UI design system may provide a standard rule bases for mapping UML elements to UI widgets, the user may modify the provided rule bases, or create their own rule bases.

It should be understood that each UI widget has a corresponding UML element that could be referred to as its UML Widget class. For example, the rule base may provide that if a UML class is a subclass of the UML Widget class (the class is a concrete class) then the UI widget being created is the instance of the UML class. As another example, if the UML element is an instance of the String class, the UI widget to be created is an instance of a UI label or UI text box and the text property of the UI widget is the text represented by the String classes string property.

B. Simulating a User-Interface

In the simulation state, State Notification System 414 of UI Design System 400 may operate in conjunction with a State Notification System 422 of MDD tool 402. When a UML model or other model capturing the functionality of UI changes state, the State Notification System 422 may notify UI design system 400 of the change via State Notification System 414. UI design system 400 can then update the visual status of the UI appropriately. For example, code representing the results of pushing a button may have executed in an underlying model. As a result, State Notification System 422 may notify State Notification System 414 that this code has executed. UI design system 400 may then update the graphical display to show the push of the button and change the visual display of the UI accordingly.

State Notification System 422 of MDD Tool 402 may take various forms. For example, the system may employ Telelogic's Rhapsody, which utilizes the Open XML framework (OXF), as an MDD tool. Such embodiments may simply employ the OXF framework of Rhapsody which includes event notification, to implement State Notification System 422. Alternatively, the MDD tool may be updated to include the State Notification System 422 that supports interaction between an MDD Tool interface (e.g., a GUI showing a UML model in a tree format, for instance). In such an embodiment, the State Notification System 422 may be implemented by extending the OXF framework. Preferably, the OXF may be extended by modifying the source code to Rhapsody.

The State Notification System 414 helps allow a user of the UI design system 400 to participate in the debugging of a UML model via the UI design system. Specifically, events in a UI model may be sent to an underlying model during execution of the underlying model. For instance, during simulation of a UI, a UML model facilitating some functionality of the UI may be executed. During execution of the underlying model, the user may interact with the UI via the UI design system 400, by pressing a button for instance. The State Notification System 414 may then send the button-press event to MDD tool 402, which in turn can communicate the event to the underlying model, executing any code that corresponds to the button-press.

More specifically, the State Notification System 414 allows a user to debug a UI as well as the UML elements or code to which objects of the UI are bound. To do so, the State Notification System 414 may work with interoperability interface 418 and/or automation interface 420 to verify a model or code that is bound to the UI widgets. To use the State Notification System 414, a user may first cause UI design system 400 to enter the simulation state (e.g. by clicking an on-screen button). When the user causes the UI design system 400 to enter the simulation state, the UI design system 400 may in turn cause the MDD tool 402 to enter the debugging state. Preferably, the UI design system 400 causes the MDD tool 402 to enter the debugging state by invoking the automation interface 420.

More particularly, in an MDD tool, such as Rhapsody, events are defined to trigger state transition in state diagrams. During the model debugging, an event may be manually triggered, such as by user interaction with a UI, which in turn triggers the model simulator. With the UI design system, the UI can be connected to a model's state machine directly with “event sending”. The event receiving objects are singletons which could receive events. For example, a state model of a machine has an internal running process. “Start” is an event to trigger the modeled state machine to run. With the machine running, the UI should show the current running state. For the “event sending”, the source object is the UI “Start” button. The UI object bound with the state machine's internal state will get notification from the machine running in the model when the state has changed. Such configurations may not employ a rule engine.

The Rule Engine 410 may be aware of the user interface objects, their representation and their bindings. The Rule Engine animates or executes the user interface by invoking methods or setting properties on the user interface object implementation in the model and invoking or setting properties. The execution is based on the rules which are interrupted much like Javascript is executed. The user interface objects themselves then modify the user interface or view based on user input that is feedback to them. The rules engine serves as a real-time interpreter of the interactions between the UI representation or view, the model and the control in the user interface objects.

In the absence of the model the rules could be codified in generated code and then compiled and loaded in an application that serves the UI instantiated system itself. The rules no longer function as an intermediary and the model is no longer in the system. The implementation of the user interface is now interacting directly with the user interface.

Once in the simulation/debugging state, the State Notification System 414 may cause MDD tool 402 to control (possibly via automation interface 420) execution of the code and/or to debug the code based on visual events in the UI being designed on the UI design system 400. If the MDD tool 402 generates executable program code from a UML model, the MDD tool 402 may insert code that allows access to and/or control of the code. The execution of the inserted code may also send updates on the status of the executing code back to the MDD tool 402. This status information can be provided to a user, who can use the information to better understand and debug the code and/or the UML model from which the code is generated.

Thus, a user can access the executing code by visually manipulating a UI. This interaction may be captured as a visual event or series of visual events. Visual events may be put in a form understandable by the MDD tool 402 and further, may be sent to the MDD tool 402 by the State Notification System 414. The MDD tool 402 can then control or access the code for the UML model, executing the code that is associated with the occurrence of the visual event.

Further, execution of the inserted code may notify MDD tool 402 of changes to the UML model as the generated code is executing. When necessary, the State Notification System 422 may respond to changes in the UML model, by notifying the UI design system 400 that changes have occurred (via the State Notification System 414). Note that notification of the UI design system 400 may occur concurrently or subsequently to notifying the MDD tool 402. In the preferred embodiment, the XML processing framework (OXF) of Rhapsody may be extended to provide notification to the UI design system 400. When notified, the UI design system 400 may update the UI so that the UI is consistent with the updated UML model. For example, the UI design system 400 may access the updated UML model with the UML model explorer 408, and use the Rule Engine 410 to interpret the changes so they can be made in the UI being verified.

This configuration provides for piece-meal and directional (i.e. stepping forward or backward) control and execution of code bound to a UI, from the UI design system. In addition, it provides feedback regarding debugging and simulation via the UI design system. As a result, the user can concurrently debug a UML model and verify the UI to which the model is bound.

### IV. Source Code Generation

Model/Code Generator 412 helps allow UI widgets to be understood and used in a UML model or a domain-level model. In particular, Model/Code Generator may generate a UML element or elements (which cumulatively may be a UML model or portion of a UML model) that correspond to objects created for a UI model in UI design system 400. The UML elements can then be used to generate source code or can be integrated with domain-level models. Alternatively or additionally, Model/Code Generator 212 may generate program code in one or programming languages directly (e.g. Java, C++). In any case, Model/Code Generator 412 is preferably implemented using template-based model transformation technology, but alternatively may be implemented using other types of model transformation.

In another example, a method for generating a model and corresponding code from a UI description may be carried out by a UI design system in conjunction with a MDD tool. First, a UML element or instance of a UML class is created for a UI page. Then, properties of the UML class may be created when UI widgets are added to the UI page. Then, by setting the parameters for the parameterized class associated with the UI page object, a constructor for the page is generated. Code may then be generated in the constructor to initialize new UI widgets defined in the UI page. Code may also be generated in the constructor for widgets or bindings in the page and setup layout. Finally, code may be generated for event handling. Bindings are method calls from one widget to another widget or screen object events are calls and callbacks between the UI and underlying implementation of application.

It should be understood that the illustrated embodiments are only examples and should not be taken as limiting the scope of the present invention. The claims should not be read as limited to the described order or elements unless stated to that effect. Therefore, all embodiments that come within the scope and spirit of the following claims and equivalents thereto are claimed as the invention.

1. A system for creating a user interface comprising:
a display for viewing a visual representation of the user interface being created;
a processor;
data storage; and
program code stored in the data storage and executable by the processor to:
implement a UML model explorer that communicates with a model driven design tool to access at least one UML model, wherein the UML model comprises one or more UML elements;
implement a Rule Engine that is operable to map the UML elements to corresponding user interface objects;
in response to input from a user, add one or more of the corresponding user interface objects to the visual representation of the user interface; and
implement a model generator that is operable to generate a UML model based on the visual representation of the user interface, wherein the UML model can be executed to create an instance of the user interface on a display.

2. The system of claim 1, further comprising program code stored in the data storage and executable by the processor to debug the generated UML model.

3. The system of claim 1, further comprising program code stored in the data storage and executable by the processor to respond to a user input by entering a simulation state to verify the visual representation of the user interface.

4. The system of claim 3, further comprising program code stored in the data storage and executable by the processor to, after entering the simulation state, detect input from a user input device and, in response, manipulate the visual representation of the user interface.

5. The system of claim 4, further comprising a model execution triggering mechanism that is operable to, in response to the manipulation of the visual representation, send an indication of the manipulation of the visual representation to the model driven design tool.

6. The system of claim 3, further comprising program code stored in the data storage and executable by the processor to receive a state notification from the model driven design tool, wherein the state notification indicates that one or more of the UML models has changed state.

7. The system of claim 6, further comprising program code stored in the data storage and executable by the processor to, in response to receiving the state notification, update the visual representation of the user interface.

8. The system of claim 6, wherein the model driven design tool comprises on OXF framework, and wherein the OXF framework has been extended to provide the state notification.

9. A system for creating a user interface comprising:
a display for viewing a visual representation of the user interface being created;
a processor;
data storage; and
program code stored in the data storage and executable by the processor to:
implement a UML model explorer that communicates with a model driven design tool to access at least one UML model, wherein the UML model comprises one or more UML elements;
implement a Rule Engine that is operable to map the UML elements to corresponding user interface objects;
in response to input from a user, add one or more of the corresponding user interface objects to the visual representation of the user interface;
implement a model generator that is operable to generate a UML model based on the visual representation of the user interface, wherein the UML model can be executed to create an instance of the user interface on a display; and
implement a simulation system operable to:
detect input from a user input device and in response to the input, manipulate the visual representation of the user interface;
receive a state notification from the model driven design tool, wherein the state notification indicates that one or more of the UML models has changed state; and
in response to receiving the state notification, update the visual representation of the user interface.

10. A method for creating a user interface with a model-centered approach, the method comprising:
importing a UML model into a user interface design tool via a model driven design tool, wherein the UML model comprises UML elements;
using the UML elements as a basis for creating user interface objects that can be used in a visual representation to create the user interface; and
creating a visual representation of the user interface, wherein the visual representation of the user interface comprises one or more of the user interface objects, and wherein the visual representation is executable to instantiate the user interface on a display.

11. The method of claim 10, further comprising executing the visual representation to instantiate the user interface on the display.

12. The method of claim 11, wherein executing the visual representation comprises generating program code from the visual representation and executing the program code.

13. The method of claim 12, wherein the program code is both generated and executed at runtime.

14. The method of claim 11, wherein executing the visual representation comprises generating program code from the UML model and executing the program code.

15. The method of claim 14, wherein the program code is both generated and executed at runtime.

16. The method of claim 10, wherein the one or more of the user interface objects comprises one or more user interface objects not based on the UML elements, the method further comprising:
using the user interface objects not based on the UML elements as a basis for creating new UML elements; and
adding the new UML elements to the UML model.

17. The method of claim 10 further comprising, after creating a visual representation of the user interface, verifying the visual representation of the user interface.

18. The method of claim 17, wherein verifying the visual representation of the user interface comprises instructing the model driven design tool to execute one or more portions of the UML model.

19. The method of claim 18, wherein instructing the model driven design tool to execute one or more portions of the UML model comprises:
while the visual representation of the user interface is in a first state, receiving input from a user input device;
in response to the input, changing the visual representation of the user interface so the visual representation is in a second state different than the first state; and
notifying the model driven design tool of the second state.

20. The method of claim 18 further comprising:
receiving an indication that the one or more portions of the UML model have been executed; and
updating the visual representation to reflect the executed portions of the UML model.
